(19) United States
(12) Patent Application Publication
(10) Pub. No.: US 2010/0190598 A1
(43) Pub. Date: Jul. 29, 2010

(54) CHAIN WITH TOOTH TYPE ROLLERS

(75) Inventor: DANIEL WU, Tainan County (TW)

Correspondence Address: ROSENBERG, KLEIN & LEE, 3458 ELLICOTT CENTER DRIVE-SUITE 101, ELLICOTT CITY, MD, 21043, US

(73) Assignee: KMC CHAIN INDUSTRIAL CO., LTD., TAINAN COUNTY (TW)

(21) Appl. No.: 12/754,880

(22) Filed: Apr. 6, 2010

Related U.S. Application Data
(63) Continuation of application No. 11/987,291, filed on Nov. 29, 2007, now abandoned.

(30) Foreign Application Priority Data
Nov. 30, 2006 (TW) 095144390
Nov. 26, 2007 (TW) 096144871

(51) Int. Cl. F16G 13/04

(52) U.S. Cl. 474/212

(57) ABSTRACT

A chain with tooth type rollers comprises a plurality of links that are levelly arranged and horizontally overlapped with each other, a plurality of pins for connecting the overlapped portions of the adjacent links and a plurality of tooth type rollers taking the respective pin as a center and positioned between the two parallel link plates of one of the links. Therein, each of the tooth type rollers is drivingly connected to the adjacent link plates. Each of the tooth type rollers has a combining portion synchronously rotating with the links and an outstanding portion protruded from the combining portion toward a chain wheel and inserted into one of tooth spaces of the chain wheel. By changing the structure of the rollers, the disclosed chain has the advantages of long service life, low operation noise and high driving efficiency.

### REFERENCE TO RELATED APPLICATION

This Application is a Continuation of patent application Ser. No. 11/987,291, filed 29 Nov. 2007, currently pending.

### BACKGROUND OF THE INVENTION

1. Technical Field

The present invention relates to chains and, more particularly, to a chain with tooth type rollers that is composed of plural link plates, a plurality of rollers and a plurality of pins, and also has the advantages as well as a roller chain and a silent chain.

2. Description of Related Art

There are generally two types of conventional chains with diverse basic structures, which are roller chains and silent chains. Therein, a traditional roller chain 1 typically has a structure as shown in FIGS. 1 and 2 for leaning against a chain wheel 10. The chain wheel 10 comprises plural tooth parts 101 spaced with identical pitches and plural tooth spaces 102 formed between each two adjacent said tooth parts 101. The roller chain 1 comprises plural spaced roller links 11, plural pin links 12 positioned between each two adjacent roller links 11, plural rollers 13 rollably installed in the roller links 11 and plural pins 14 for linking the adjacent links 11 and 12. Each of the roller links 11 comprises two horizontally parallel inner link plates 111 and a bushing 113 passing through horizontally corresponding holes 112 on the inner link plates 111. Each of the pin links 12 comprises two horizontally spaced outer link plates 121 that are respectively positioned aside outer sides of the two adjacent inner link plates 111. Each of the rollers 13 is a hollow column and rotatably mounted around the bushing 113 so as to be positioned between the two parallel inner link plates 111.

In operation of the traditional roller chain 1, the tooth parts 101 on the chain wheel 10 are inserted between two inner link plates 111 or outer link plates 121 while the rollable rollers 13 are leaning against the tooth spaces 102 of the chain wheel 10. However, as the hollow columnar rollers 13 take a relatively large engagement angle 15 to enter the tooth spaces 102, the rollers 13 consequently impact the chain wheel 10 from a relatively higher place and therefore cause a relatively large deliver noise. Moreover, since the rollers 13 and the bushings 113 are assembled with intervals therebetween, at the moment the rollers 13 touch the tooth spaces 102, the rollers 13 also impact the bushings 113 and therefore aggravate the deliver noise. Meantime, depressed deliver efficiency is consequently induced.

On the other hand, a traditional silent chain 2 typically has a structure as shown in FIGS. 3 and 4 for leaning against a chain wheel 20 that comprises plural tooth parts 201 and plural tooth spaces 202. The silent chain 2 comprises plural guide links 21, plural articular links 22 positioned between each two adjacent guide links 21, and plural pins 23 for linking the links 21 and 22. Therein, each of the guide links 21 comprises two horizontally spaced outer link plates 211 and plural guide link plates 212 positioned between and horizontally overlapped the outer link plates 211. Each of the articular links 22 comprises plural articular link plates 221 each having an identical shape with the guide link plate 212 and place levelly overlapping the guide link plate 212. Each of the articular link plates 221 is positioned between one adjacent outer link plate 211 and one adjacent guide link plate 212 or between two adjacent guide link plates 212. The pins 23 connect the guide links 21 and the articular links 22 overlapping the guide links 21. Further, each of the guide link plates 212 has two place levelly spaced tooth portions 213 and a leaning recess 214 formed between the spaced tooth portions 213. Each of the articular link plates 221 has two place levelly spaced tooth portions 222 and a leaning recess 223 formed between the spaced tooth portions 222. The leaning recesses 214 and 223 are shaped to match the tooth parts 201. In operation, the tooth portions 213 and 222 are inserted into the tooth spaces 202, while the tooth parts 201 are inserted into the aligned leaning recesses 214 and 223, so as to achieve benefits of smooth engagement and low deliver noise.

In operation of the traditional silent chain 2, since the link plates 212 and 221 take an engagement angle 24 smaller than the engagement angle 15 of the roller chain 1 in FIG. 1 and FIG. 2 to enter the tooth spaces 202, the impact force occurring during the engagement therebetween is relatively small and the operation noise is relatively low. However, during operation, pulling force acting on the silent chain 2 is distributed to the positions where the link plates 212 and 221 connect the pins 23. As time passes, the jointing portions between the link plates 212, 221 and the pins 23 are liable to be worn, resulting in enlarged intervals among components. As a result, the silent chain 2 will be tugged to become lengthened and unusable. Thus, it is evident that though the traditional silent chain 2 possesses the advantage of low operation noise, it has the disadvantage of shorting service life.

### SUMMARY OF THE INVENTION

The present invention has been accomplished under these circumstances in view. It is that main objective of the present invention to provide a chain with tooth type rollers having the advantages of low operation noise, high driving efficiency and long service life.

To achieve these and other objectives of the present invention, the chain with tooth type rollers comprises a plurality of links that are levelly arranged and horizontally overlapped with each other, a plurality of pins for connecting the overlapped portions of the adjacent links and a plurality of tooth type rollers taking a respective pin as a center and positioned between two parallel link plates of one of the links.

Therein, each of the tooth type rollers is drivingly connected to the adjacent link plates. Each of the tooth type rollers has a combining portion synchronously rotating with the links and an outstanding portion protruded from the combining portion toward a chain wheel and inserted into one of tooth spaces of the chain wheel. By changing the structure of the rollers, the disclosed chain can achieve the effects of low operation noise, high driving efficiency and long service life.

The leaning surface of the outstanding portion can be a symmetrical or an asymmetrical design. The preferred embodiments of the symmetrical design includes that the two leaning surfaces are flat or non-flat. The non-flat can be a convex arc shape, a concave arc shape or an irregular shape. In the preferred embodiment of the asymmetrical design of the present invention, a leaning surface of the outstanding portion can be flat or non-flat. Another leaning surface is composed of at least two line slices with different curvatures, such as the composition formed by flat and the arc line slice, or the composition formed by two arc line slices with different curvatures.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 illustrates a partial top view of a traditional roller chain;

FIG. 2 illustrates a partial side view of the traditional roller chain, showing the relation between the chain and a chain wheel;

FIG. 3 illustrates a partial exploded view of a traditional silent chain;

FIG. 4 illustrates a partial side view of the traditional silent chain, showing the relation between the chain and a chain wheel;

FIG. 5 illustrates a partial exploded view of the chain according to a first embodiment of the present invention taken from a top viewpoint;

FIG. 6 illustrates a partial side view of the chain according to the first embodiment of the present invention, showing the relation between the chain and a chain wheel;

FIG. 7 illustrates a partial exploded view of the chain according to the first embodiment of the present invention, showing the two links, one pin and two tooth type rollers of the chain merely;

FIG. 8 illustrates a partial side view of the chain according to a second embodiment of the present invention, showing a tooth type roller of the chain alone;

FIG. 9, similar to FIG. 8, illustrates a partial side view of the chain according to a third embodiment of the present invention;

FIG. 10, similar to FIG. 8, illustrates a partial side view of the chain according to a fourth embodiment of the present invention;

FIG. 11A, similar to FIG. 8, illustrates a partial side view of the chain according to a fifth embodiment of the present invention;

FIG. 11B, similar to FIG. 8, illustrates a partial side view of the chain according to a sixth embodiment of the present invention;

FIG. 11C, similar to FIG. 8, illustrates a partial side view of the chain according to a seventh embodiment of the present invention;

FIG. 11D, similar to FIG. 8, illustrates a partial side view of the chain according to an eighth embodiment of the present invention;

FIG. 12, similar to FIG. 5, illustrates a partial top view of the chain according to a ninth embodiment of the present invention;

FIG. 13 illustrates a partial exploded view of the chain according to the ninth embodiment of the present invention;

FIG. 14 illustrates a partial exploded view of the chain according to a tenth embodiment of the present invention;

FIG. 15A, similar to FIG. 5, illustrates a partial top view of the chain according to an eleventh embodiment of the present invention;

FIG. 15B, similar to FIG. 5, illustrates a partial top view of the chain according to a twelfth embodiment of the present invention;

FIG. 16, illustrates a measuring diagram of the tooth type roller shown in FIG. 11B, FIG. 11C or FIG. 11D incorporating with the chain shown in FIG. 15A or FIG. 15B;

FIG. 17 illustrates a partial exploded view of the chain according to a thirteenth embodiment of the present invention;

FIG. 18 illustrates a partial exploded view of the chain according to a fourteenth embodiment of the present invention;

FIG. 19, similar to FIG. 17, illustrates a partial exploded view of the chain according to a fifteenth embodiment of the present invention;

FIG. 20, similar to FIG. 17, illustrates a partial exploded view of the chain according to a sixteenth embodiment of the present invention;

FIG. 21 illustrates a partial exploded view of the chain according to a seventeenth embodiment of the present invention;

FIG. 22, similar to FIG. 17, illustrates a partial exploded view of the chain according to an eighteenth embodiment of the present invention;

FIG. 23, similar to FIG. 17, illustrates a partial exploded view of the chain according to a nineteenth embodiment of the present invention;

FIG. 24 illustrates an applied view of the chain according to a twentieth embodiment of the present invention;

FIG. 25 illustrates a partial side view of the chain according to the twentieth embodiment of the present invention, showing a tooth type roller of the chain alone;

FIG. 26, similar to FIG. 25, illustrates a partial side view of the chain according to a twentieth-first embodiment of the present invention;

FIG. 27, similar to FIG. 25, illustrates a partial side view of the chain according to a twentieth-second embodiment of the present invention;

FIG. 28, similar to FIG. 14, illustrates a partial exploded view of the chain according to a twentieth-third embodiment of the present invention;

FIG. 29, similar to FIG. 28, illustrates a partial exploded view of the chain according to a twentieth-fourth embodiment of the present invention; and

FIG. 30 illustrates a partial exploded view of the chain according to a twentieth-fifth embodiment of the present invention.

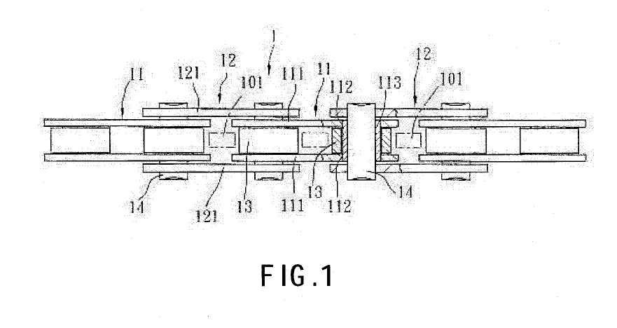

### DETAILED DESCRIPTION OF THE PREFERRED EMBODIMENT

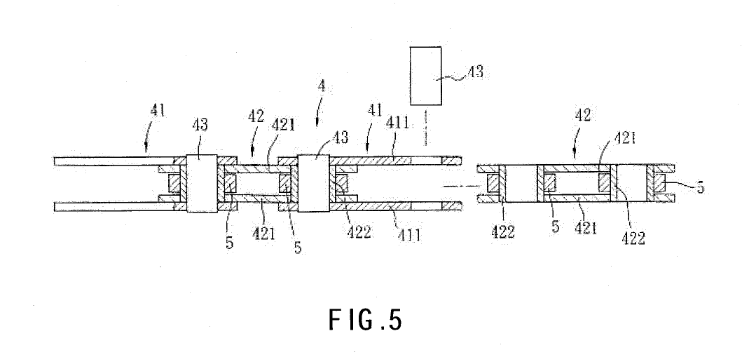

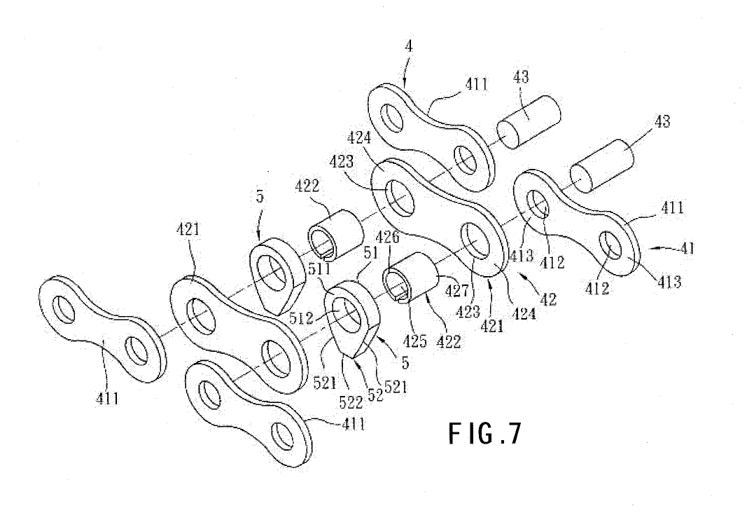

Please refer to FIGS. 5, 6 and 7. A chain 4 according to a first embodiment of the present invention is provided to lean against a chain wheel 3. The chain wheel 3 comprises a plurality of tooth parts 31 annularly arranged and spaced with identical pitches and a plurality of tooth spaces 32 formed between each two adjacent tooth parts 31. Each of the tooth parts 31 has two convex surfaces 311 respectively facing the adjacent tooth spaces 32. The chain 4 of the present embodiment comprises a plurality of place levelly spaced first links 41, a plurality of second links 42 positioned between two adjacent first links 41, a plurality of pins 43 for connecting the first and second links 41, 42 at overlapped portions where they overlap with each other and a plurality of tooth type roller 5 taking a respective pin 43 as a center thereof and positioned in the second link 42.

Each of the first links 41 comprises two horizontally spaced first link plates 411. Each of the first link plates 411 further comprises two distantly spaced ends 413 having a hole 412 respectively. Each of the second links 42 comprises two second link plates 412 positioned between the two first link plates 411, and two bushings 422. Each of the second link plates 421 further comprises two distantly spaced ends 424 having a hole 423 respectively. Each of the bushings 422 is closely fitted with the holes 423 at corresponding sides of the second link plates 421, whereby the second link plates 421 are drivingly connected. Each of the bushings 422 has an inner annular surface 426 and an outer annular surface 427 which jointly defining a passage 425. According to the present embodiment, each of the pin 43 passes through the passage 425 of one of the bushings 422 and then engages with the corresponding hole 412 of the first link plate 411. Further, the pin 43 is drivingly connected to the first link 41, and thereby the second link 42 can rotate while taking the pin 43 as a center.

The tooth type roller 5 according to the first embodiment of the present invention is closely fitted with the bushing 422 and positioned between the two horizontally parallel second link plates 421. The tooth type roller 5 comprises a combining portion 51 surrounding the outer annular surface 427 of the bushing 422 and a first outstanding portion 52 extending toward one of the tooth spaces 32 of the chain wheel 3 from the combining portion 51. Therein, the combining portion 51 has an annular wall 511 surrounding the bushing 422, and a positioning hole 512 defined by the annular wall 511 and closely fitted with the outer annular surface 427 of the bushing 422. The first outstanding portion 52, having a shape of matching that of the tooth space 32 of the chain wheel 3, comprises two leaning surfaces 521 that are levelly spaced and adjoined toward the chain wheel 3 and a connecting plane 522 connected to bottom ends of the two leaning surfaces 521. In the present embodiment, the leaning surfaces 521 are slightly convex shapes.

During operation of the chain 4 of the present embodiment, the tooth parts 31 of the chain wheel 3 are respectively inserted between two horizontally parallel first or second link plates 411 and 421. Since the first outstanding portions 52 of the tooth type roller 5 is protruded toward the tooth spaces 32. Each of the first outstanding portions 52 taking a relatively small engagement angle, which is similar to that of a conventional silent chain, is smaller than a conventional traditional roller chain while leaning against the chain wheel 3. Further, as described above, the tooth type rollers 5 closely fit the bushings 422 without intervals therebetween. Thus, the present embodiment has the advantages of high driving efficiency and low operation noise as well as the conventional silent chain. On the other hand, the second link plates 421 are drivingly connected by the bushings 422, and the tooth type rollers 5 are also drivingly connected to the bushings 422 when the first link plates 411 are drivingly connected to the pins 43. Thus, when all the components receive forces during operation, the received pulling forces taken by the first link plates 411 are concentrated to the pins 43, and the received pulling forces taken by the second link plates 421 are also connected to the bushings 422 so as to form integration. In another word, the portions of taking forces are concentrated on the bushings 422 and the pins 43 to lean against each other. Therefore, such design also possesses the advantages of high wear durability and long lifetime as well as the conventional roller chain.

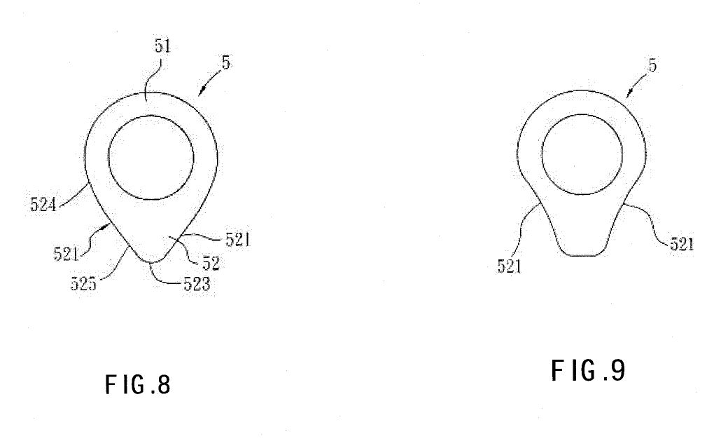

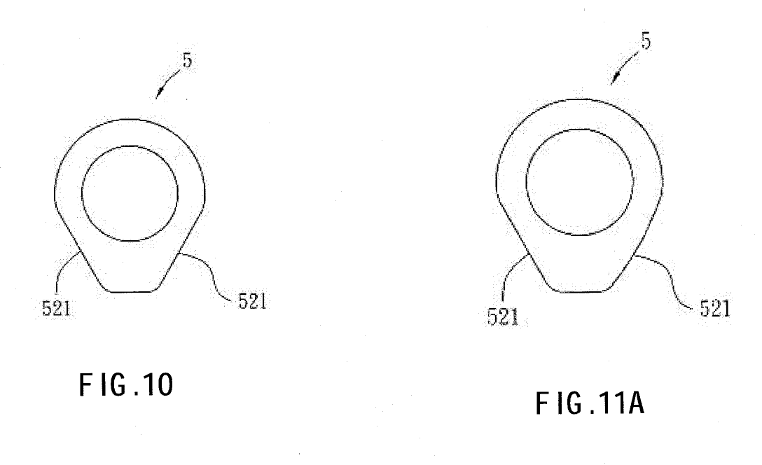

Referring to FIGS. 8 to 10, a second to a fourth embodiment of the present invention each has a structure similar to that of the first embodiment are provided when the only differences are the diverse shapes of the tooth type rollers 5 for adapting to chain wheels having diversely shaped tooth parts (not shown). As shown in FIG. 8, according to the second embodiment of the present invention, the tooth type roller 5 also comprises a combining portion 51 and a first outstanding portion 52. Therein, the first outstanding portion 52 comprises two place levelly spaced leaning surfaces 521 and an arched connecting surface 523 connected to bottom ends of the two leaning surfaces 521. Each of the leaning surfaces 521 includes a first slice 524 adjacent to the combining portion 51 and a second slice 525 located between the first slice 524 and the arched connecting surface 523, wherein the first and second slices 524, 525 have different curvatures. Dissimilarly, in the third embodiment of the present invention, the leaning surfaces 521 of the tooth type roller 5 are concave shapes while in the fourth embodiment of the present invention, leaning surfaces 521 of the tooth type roller 5 are flat.

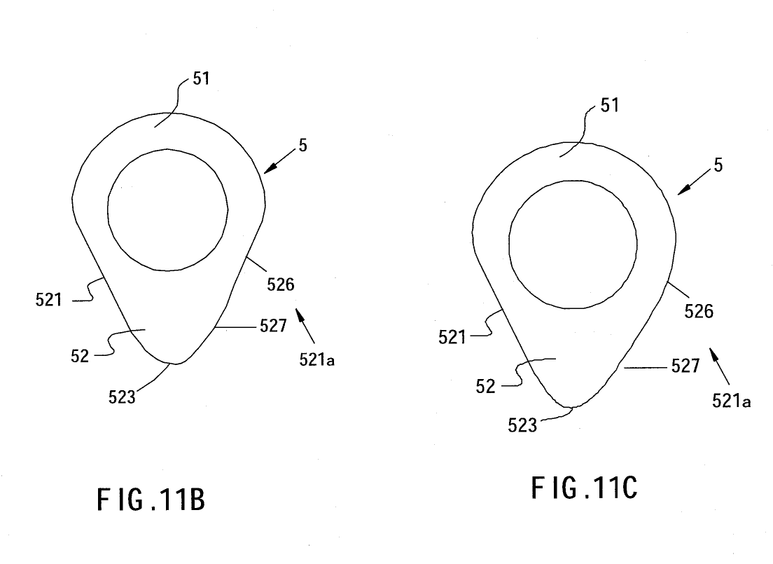

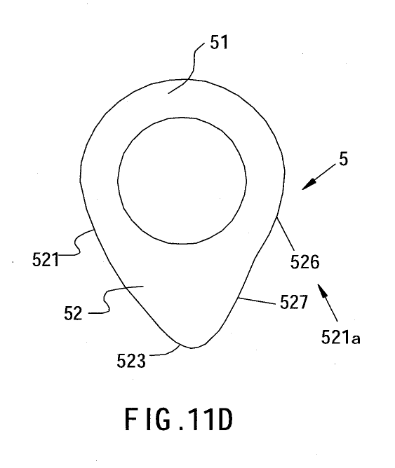

Referring to FIG. 11A to 11D, the leaning surface 521 of the tooth type roller 5 according to the first to fourth preferred embodiment of the present invention is a symmetrical design. The two leaning surfaces 521 of the tooth type roller 5 of the present invention can also be an asymmetrical design in actual practice. Therefore, four preferred embodiments are taken as an illustration herein. As shown in FIG. 11A, a leaning surface 521 of the tooth type roller 5 according to the fifth preferred embodiment of the present invention is flat when another leaning surface 521 is non-flat.

As shown in FIG. 11B, a leaning surface 521 of the tooth type roller 5 according to the sixth preferred embodiment of the present invention is flat. Another leaning surface 521a includes a third slice 526 adjacent to the combining portion 51 and a fourth slice 527 between the third slice 526 and the arched connecting surface 523, wherein the fourth slice 527 is an arc shape when the third slice 526 is flat.

As shown in FIG. 11C, a leaning surface 521 of the tooth type roller 5 according to the seventh preferred embodiment of the present invention is flat. The third slice 526 and the fourth slice 527 of another leaning surface 521a are arc shapes, and the third slice 526 and the fourth slice 527 have different curvatures. As shown in FIG. 11D, a leaning surface 521 of the tooth type roller 5 according to an eighth preferred embodiment of the present invention is an arc shape. The third slice 526 and the fourth slice 527 of another leaning surface 521a are arc shapes, and the third slice 526 and the fourth slice 527 can have different curvatures.

It should be noted that the asymmetrical design of the leaning surface of the tooth type roller taken by the foregoing preferred embodiments is only an example, and should not be limited therein. The leaning surface 521 of the tooth type roller 5 can be flat or non-flat. The leaning surface 521a can be composed of at least two line slices with different curvatures. For example, the leaning surface 521a can be composed of both flats or both arc line slices, the leaning surface 521a can be composed of flat incorporating with the arc line slices, but it is not limited to the foregoing slices. As long as the leaning surfaces composed of at least two line slices or at least two line slices with different curvatures should be in the scope of the present invention.

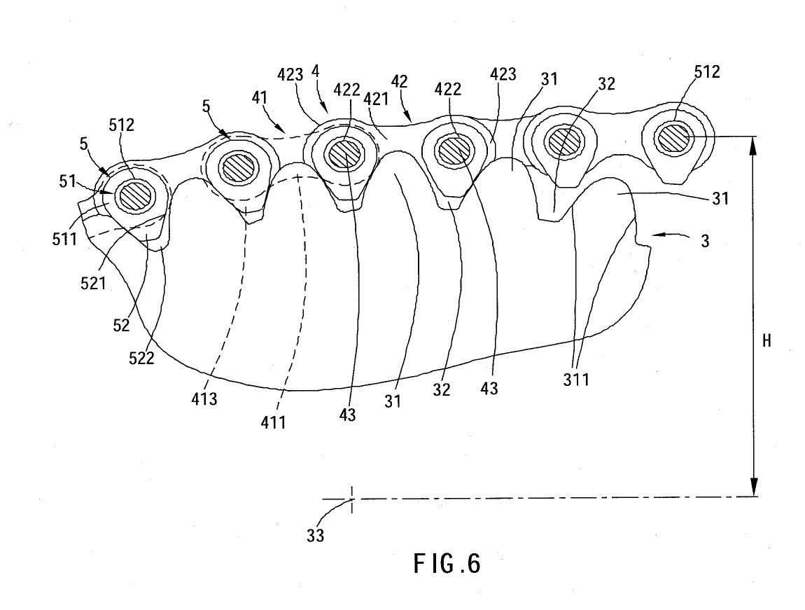

By the preferred embodiments of the present invention illustrating the asymmetrical design of the tooth type roller 5 shown in FIG. 11B-11D, the fourth slice 527 of the tooth type roller 5 is in contact with the convex surface 311 of the tooth parts 31 for engagement as shown in FIG. 6 (the chain 4) when the first outstanding portion 52 of the tooth type roller 5 leans against the tooth space 32 of the chain wheel 3. After the tooth type roller 5 is completely engaged with the tooth part 31, the contact point generated by the fourth slice 527 and the convex surface 311 is raised. The third slice 526 and the leaning surface 521 then are in contact with the convex surface 311. By using the asymmetrical design, the engagement status of the tooth type roller 5 of the present invention could reduce the swinging margin of the chain while in operation, thereby effectively reducing vibrations and noise.

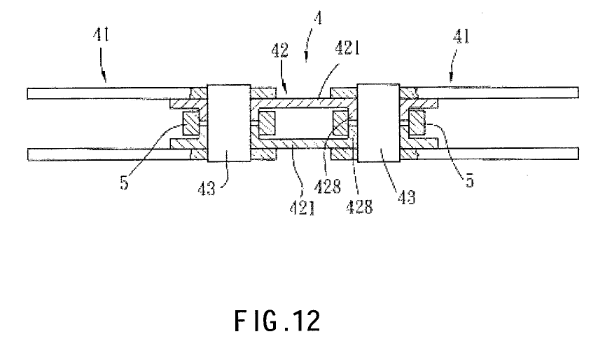

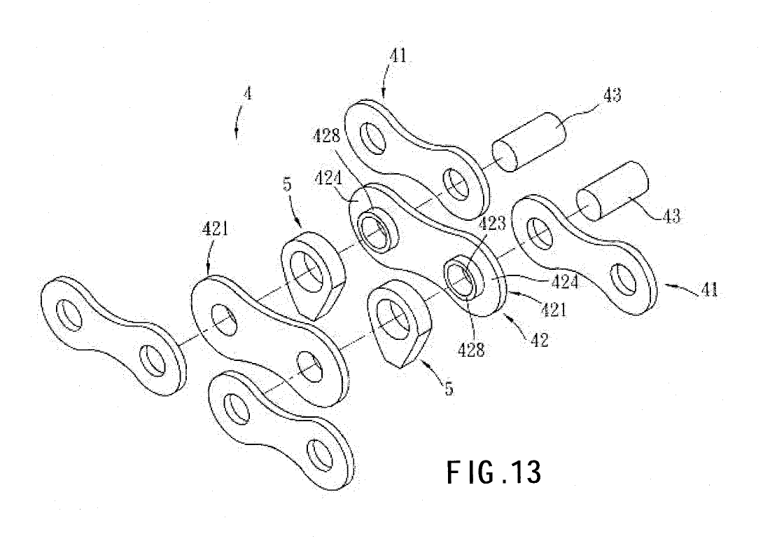

Referring to FIGS. 12 and 13, a chain 4 according to a ninth embodiment of the present invention is equipped with no bushing but also comprises first links 41, second links 42, pins 43 and tooth type rollers 5. In the present embodiment, the tooth type rollers 5 may have the shape of any of those mentioned in the first to eighth embodiments. The first links 41 and the pins 43 have the structures identical to those of the first embodiment. The second link 42 comprises two second link plates 421. The second link plate 421 further comprises two distantly spaced ends 424 having a hole 423 respectively and two protruding parts 428 respectively protruded from one of the distantly ends 424 and surrounding one of the holes 423. Thereupon, the objective of the present invention can be also achieved.

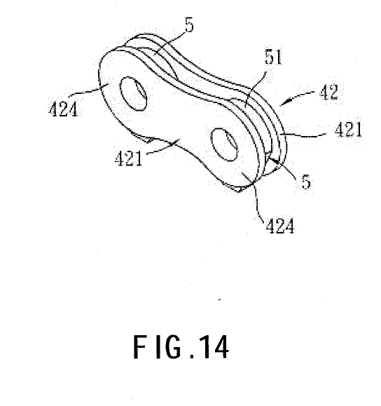

Referring to FIG. 14, a tenth embodiment has a structure similar to that of the ninth embodiment and also comprises first links (not shown), second links 42, pins (not shown) and tooth type rollers 5. What makes the tenth embodiment different from the ninth embodiment is that two second link plates 421 of the second link 42 and two of the tooth type rollers 5 are metallurgically formed as integration. In other words, combining portions 51 of the tooth type rollers 5 are integrated with the distantly spaced ends 424 of the second link plates 421. Thereby, the objective of drivingly connecting the tooth type rollers 5 and the second links 42 can be also achieved.

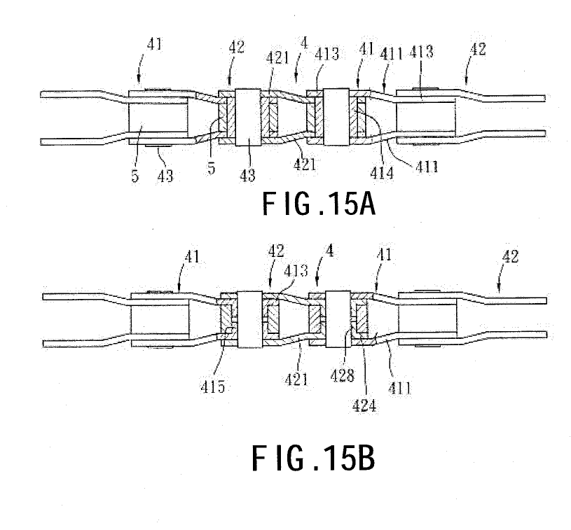

Referring to FIG. 15A, an eleventh embodiment of the present invention also comprises first links 41, second links 42, pins 43 and tooth type rollers 5. The tooth type roller 5 may be shaped as any of those described in the first to eighth embodiment and may not be illustrated by drawings herein. In the eleventh embodiment, the first links 41 and the second links 42 have identical structures. The first link 41 comprises two place levelly spaced first link plates 411 and a bushing 414. A height difference exists between two distantly spaced ends 413 of each first link plate 411. The bushing 414 is closely combined among the first link plates 411 and two second link plates 421 of the adjacent second link 42. The chain 4 according to a twelfth embodiment shown in FIG. 15B has a structure similar to that of the eleventh embodiment, and what makes the twelfth embodiment different from the eleventh embodiment is that the distantly spaced ends 413, 424 of the link plates 411, 421 of the links 41, 42 have protruding parts 415, 428 to substitute the bushings.

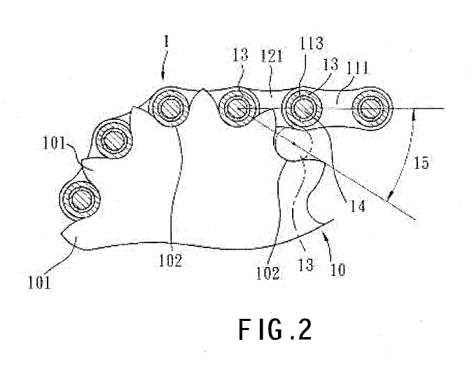

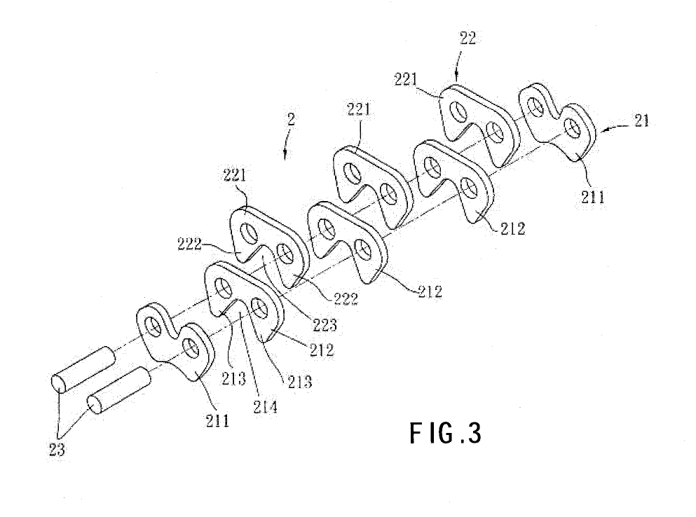

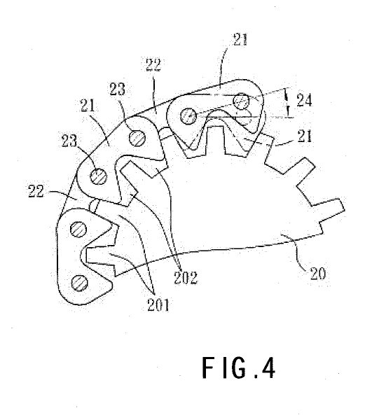

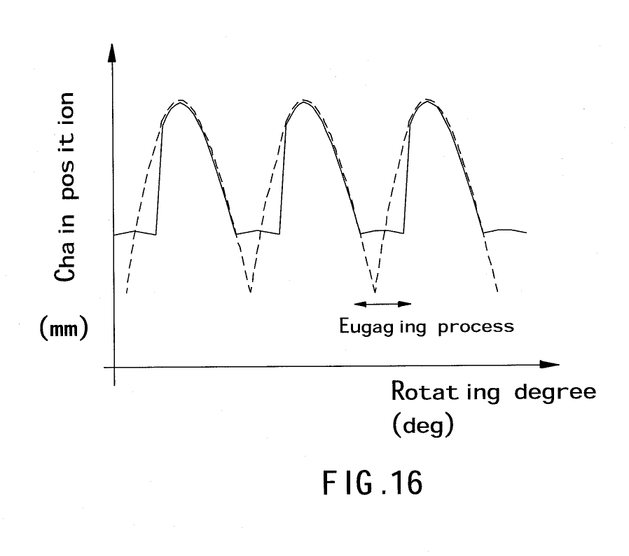

Referring to FIG. 6, a position H is defined as a vertical distance between the central point 33 of the chain wheel 3 and the center of the positioning hole 512 of the tooth type roller 5 which are not in contact with the chain wheel 3. Referring to FIG. 16, when the chain 4 of the present invention shown in FIG. 15A or FIG. 15B is incorporated with the tooth type roller 5 of the present invention shown in FIG. 11B, FIG. 11C or 11D, the solid line represents the corresponding curve that is the relationship between the position of the chain 4 and the rotating angle of the chain wheel 3. The dashed line represents the corresponding curve that is the relationship between the position of the chain 4 and the rotating angle of the chain wheel while using the conventional rollers. The roller is in contact with the tooth space 102 (as shown in FIG. 2) directly when the conventional roller chain is engaged with the chain wheel 10. The chain then easily swings during the engagement process, resulting in larger variations as shown in the dashed line. In the preferred embodiment of the present invention, while engaging with the chain 4, the fourth slice 521 of the tooth type roller 5 is in contact with the convex surface 311 of the tooth part 31 in advance so that the engagement angle is smaller than the conventional roller chain, resulting in smaller variations. Namely, the difference between the highest position and the lowest position is small. Accordingly, the tooth type roller 5 of the present invention can efficiently reduce the vibration and noise generated by the chain 4 during the engagement process.

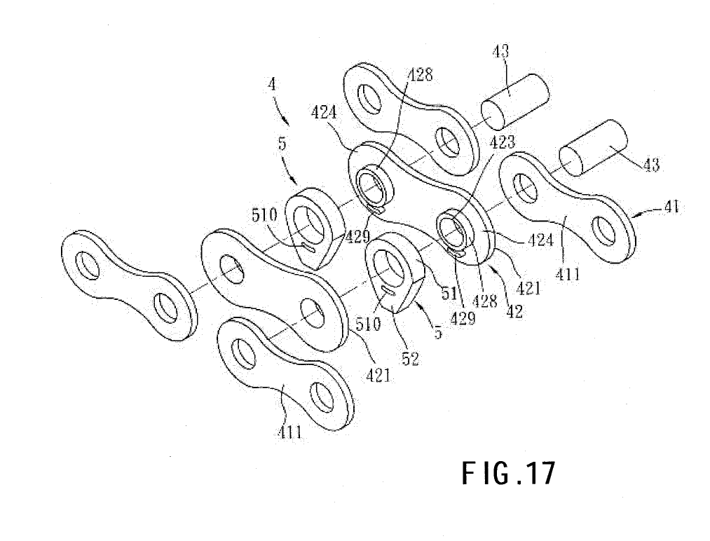

Through in the foregoing embodiments, the tooth type rollers 5 and the second links 42 are closely fitted with each other or drivingly connected as integration, it would be understood by those skilled in the art that there are many other feasible methods for orientating the first outstanding portion 52 of the tooth type roller 5 to protrude toward a chain wheel. Please referring to FIG. 17, a thirteenth embodiment has a structure similar to that of the ninth embodiment and also comprises first links 41, second links 42, pins 43 and tooth type rollers 5. Therein, the first link 41 comprises two parallel first link plates 411, and the second link 42 comprises two second link plates 421 positioned between the first link plates 411. Each of the second link plates 421 further comprises two distantly spaced ends 424 having a hole 423 respectively and two protruding parts 428 protruded from a respective distantly spaced end 424 and surrounding a respective hole 423. Each of the tooth type rollers 5 comprises a combining portion 51 and a first outstanding portion 52 protruded from the combining portion 51 toward a chain wheel (not shown).

What makes the thirteenth embodiment different from the ninth embodiment is that the second link plate 421 further comprises two retaining blocks 429 adjacent to the two protruding parts 428 and protruded toward the tooth type roller 5. Meantime, one retaining recess 510 is correspondingly provided on the combining portion 51 of the tooth type roller 5 for receiving one of the retaining blocks 429 so that the tooth type roller 5 can rotate with the second link 42 synchronously.

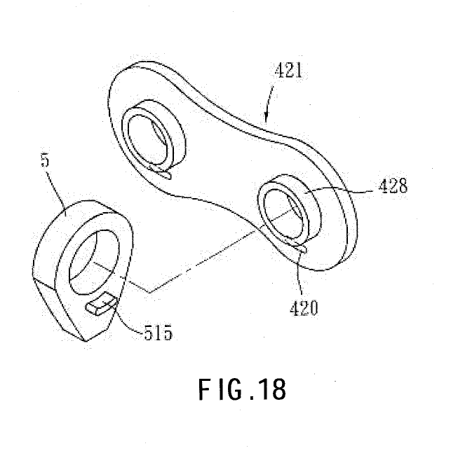

According to FIG. 18, a chain 4 according to a fourteenth embodiment of the present invention has a structure similar to that of the thirteenth embodiment, and what makes the fourteenth embodiment different from the thirteenth embodiment is that two retaining recesses 420 are provided on the second link plate 421 and respectively adjacent to two protruding parts 428. Correspondingly, two retaining blocks 515 are respectively provided on reverse sides of the combining portion 51 of the tooth type roller 5 for respectively inserting into the retaining recesses 420 of one of the second link plates 421.

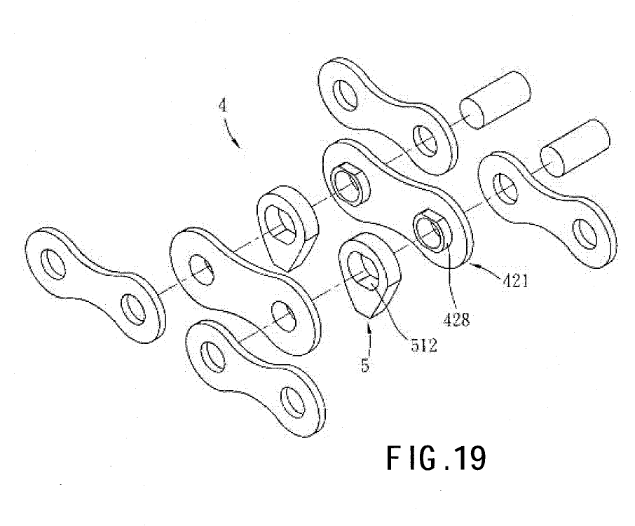

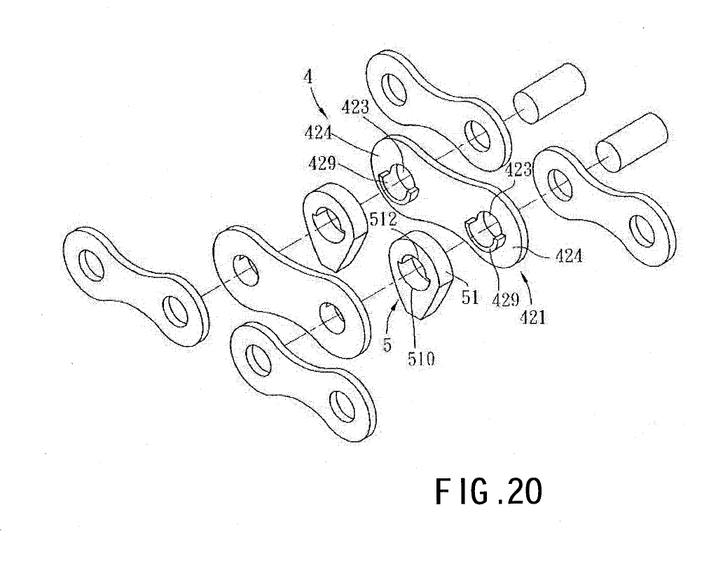

In FIG. 19, a chain 4 according to a fifteenth embodiment of the present invention has a structure similar to that of the ninth embodiment, and what makes the fifteenth embodiment different from the ninth embodiment is that each protruding part 428 of the second link plates 421 has a non-round slice shape and each positioning hole 512 of the tooth type roller 5 also has a non-round slice shape that matches the protruding part 428. Referring to FIG. 20, a chain 4 according to a sixteenth embodiment of the present invention has a structure similar to that of the first embodiment, and what makes the sixteenth embodiment different from the first embodiment is that two incomplete-annular retaining blocks 429 are respectively provided on two distantly spaced ends 424 of the second link plate 421 and partially surrounds the holes 423. In addition to the positioning hole 512 provided to the combining portion 51 of the tooth type roller 5, there are a positioning hole 512 and a retaining recess 510 for communicating the positioning hole 512 and receiving the retaining blocks 429.

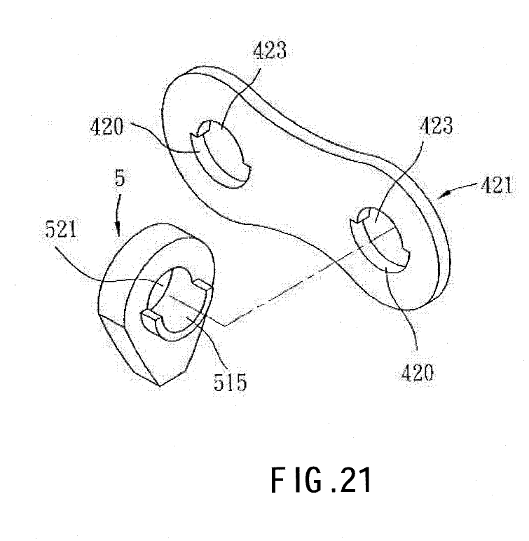

In FIG. 21, a chain according to a seventeenth embodiment of the present invention has a structure similar to that of the sixteenth embodiment, and what makes the seventeenth embodiment different from the sixteenth embodiment is that second link plate 421 has two holes 423 and two retaining recesses 420 communicating the respective hole 423. The tooth type roller 5 has a positioning hole 512 and a retaining block 515 surrounding the positioning hole 512 for inserting into the retaining recess 420, wherein the retaining block 515 is connected to a periphery of the positioning hole 512.

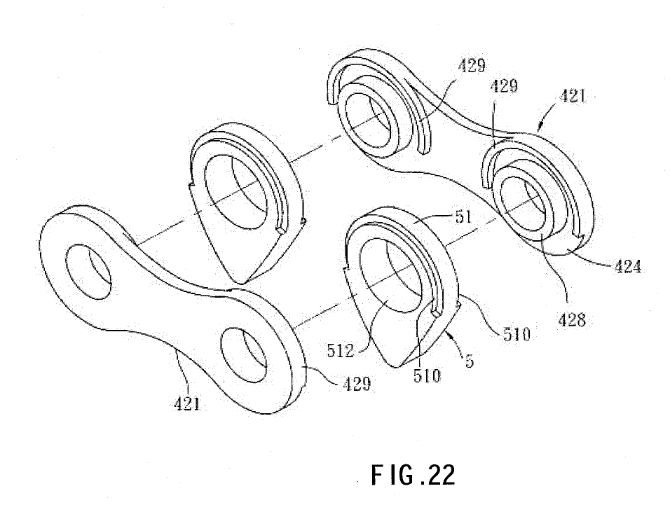

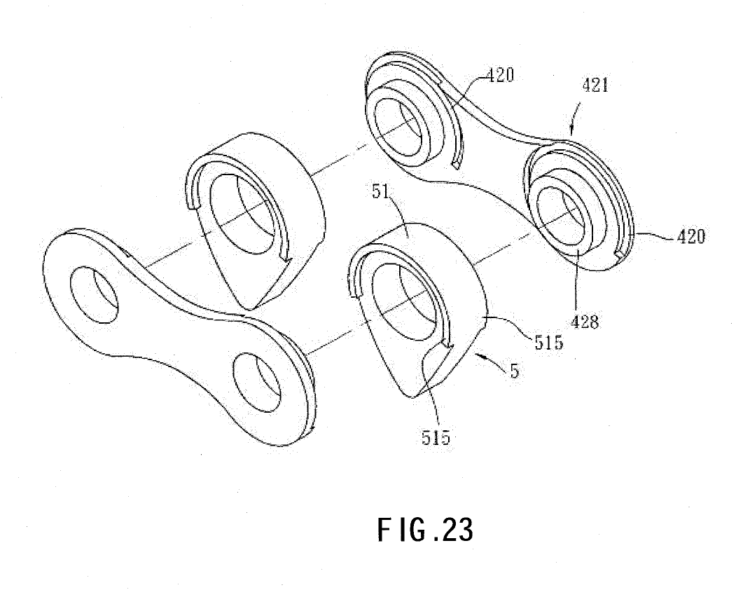

FIG. 22 is provided for illustrating an eighteenth embodiment of the present invention. The present embodiment has a structure similar to that of the ninth embodiment, and what makes the eighteenth embodiment different from the ninth embodiment is that second link plate 421 further has two retaining blocks 429 which surround the protruding part 428 and adjacent to peripheries of distantly spaced ends 424 respectively. The combining portion 51 of tooth type roller 5 further has two retaining recesses 510 surrounding the positioning holes 512 for receiving a respective retaining block 429. Therein, the retaining recesses 510 respectively face the adjacent second link plate 421. By changing the structure, the objective of drivingly rotating the tooth type rollers 5 and the second link plates 421 is achieved. Now referring to FIG. 23, a nineteenth embodiment of the present invention has a structure similar to that of the eighteenth embodiment, and the difference between the nineteenth embodiment and the eighteenth embodiment is that the positions of the retaining blocks and the retaining recesses are reversed positioned. Namely, each second link plate 421 has two spaced retaining recesses 420 surrounding the protruding parts 428 and the combining portion 51 of each tooth type roller 5 has two retaining blocks 515 that can be respectively inserted into the respective retaining recesses 420 of the adjacent second link plate 421.

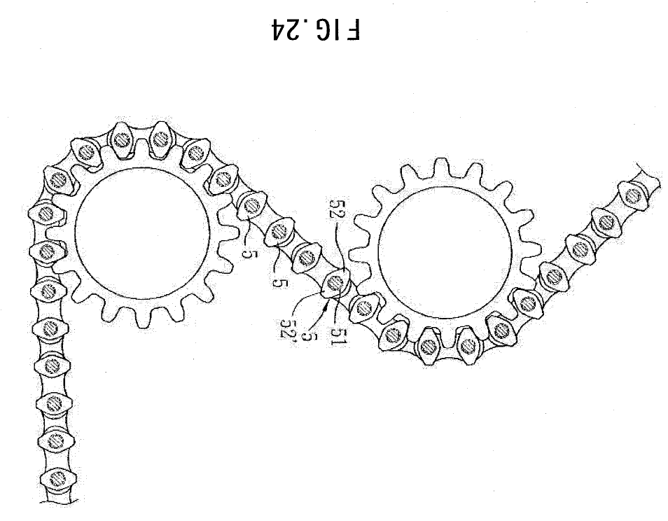

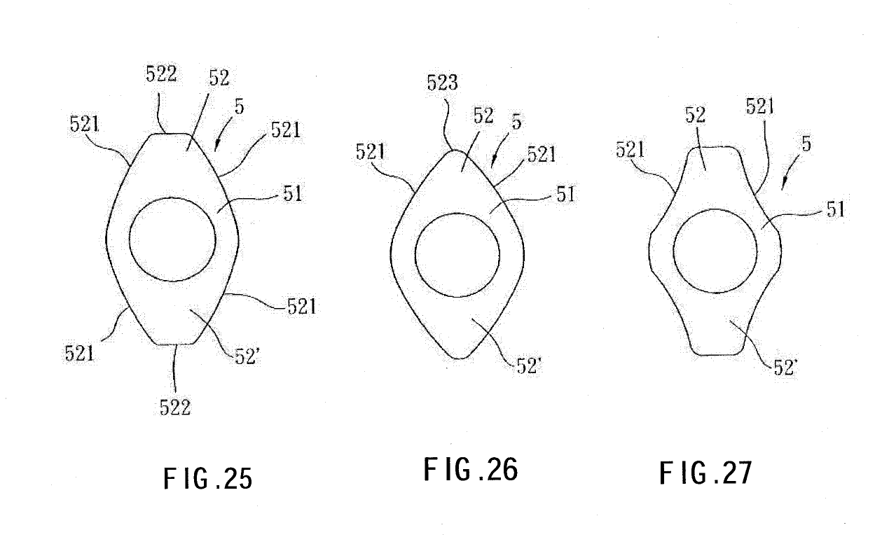

Each of the tooth type rollers 5 disclosed in the above embodiments comprises a combining portion 51 and a first outstanding portion 52. For adapting to a derailleur mechanism, the chain may be shaped as the structure shown in FIGS. 24 and 25, according to a twentieth embodiment of the present invention. Therein, each tooth type roller 5 comprises a second outstanding portion 52′ in addition to a combining portion 51 and a first outstanding portion 52. The first and second outstanding portions 52, 52′ are provided at opposite sides of the combining portion 51. Each of the first and second outstanding portions 52, 52′ has two leaning surfaces 521 and a connecting plane 522 connected to bottom ends of the leaning surfaces 521. In addition to the structure shown in FIG. 25, each of the first and second outstanding portions 52, 52′ of the tooth type roller 5 may be alternatively shaped as the structure shown in FIG. 26 according to a twentieth-first preferred embodiment of the preset invention, having two leaning surfaces 521 and an arched connecting surface 523 or may be alternatively shaped as the structure shown in FIG. 27 according to a twentieth-second preferred embodiment of the present invention, having concave leaning surfaces 521.

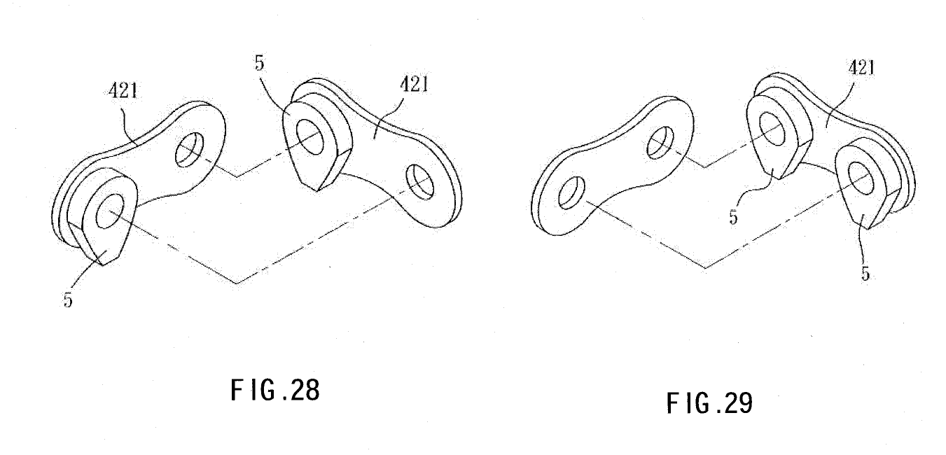

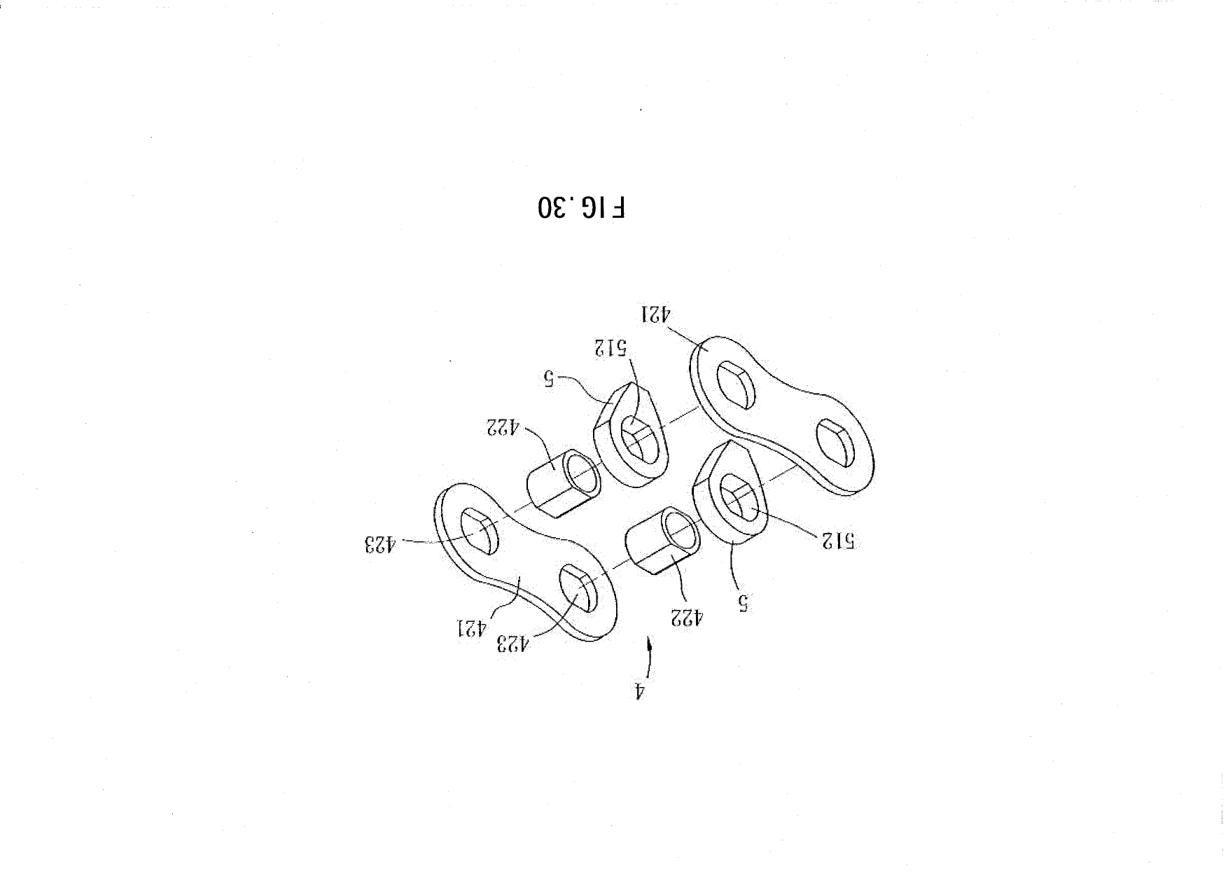

Now referring to FIGS. 28 and 29, a twentieth-third embodiment and a twentieth-fourth embodiment of the present invention have structures similar to that of the tenth embodiment in FIG. 14. While the two second link plates 421 of the tenth embodiment are metallurgically formed with two of the tooth type rollers 5 as integration, in the twentieth-third embodiment, two tooth type rollers 5 are respectively integrally formed with one second link plate 421 and in the twentieth-fourth embodiment, two tooth type rollers 5 are integrally formed with either of two second link plates 421. By changing the combination relationship between the second link plates 421 and the tooth type rollers 5, the same objective of the present invention can be also achieved.

Please referring to FIG. 30, a twentieth-fifth embodiment of the present provides a chain 4 with bushings 422. According to the present invention, the bushing 422 of the chain 4 has a non-round slice shape while holes 423 of the second link plate 421 are in a corresponding non-round slice shape, and the positioning hole 512 of the tooth type roller 5 is also shaped into a non-round slice shape so as to achieve the object of driving connection.

Besides that the chains 4 of the above-mentioned embodiments implementing the pins 43 to pierce through the overlapping portions of the two first link plates 411 and the two second link plates 421, alternatively, the pins 43 may be used to pierce through the plurality of first link plates 411, the plurality of second link plates 421 and the plurality of tooth type rollers 5. More modifications need not to be illustrated by drawings herein.

Although the particular embodiments of the invention have been described in detail for purposes of illustration, it will be understood by one of ordinary skill in the art that numerous variations will be possible to the disclosed embodiments without going outside the scope of the invention as disclosed in the claims.

What is claimed is:

1. A chain with tooth type rollers for engaging with a chain wheel, said chain wheel having a plurality of tooth parts which are circularly arranged and a plurality of tooth spaces formed between each two adjacent said tooth parts, said chain comprising:
a plurality of links horizontally spaced, wherein each of said links comprises two horizontally spaced link plates, each of said link plates has distantly spaced one first end and one second end, such that said first end and said second end define a hole respectively, in which a height difference exists between said two distantly spaced ends, and said second end overlaps with a portion of said first end of said link plates of said adjacent links;
a plurality of pins fitted with said holes for connecting said overlapped link plates of said adjacent links with each other; and
a plurality of tooth type rollers taking said pins as a center thereof and positioned between said horizontally spaced link plates of one of said links, each of said tooth type rollers having a combining portion closely fitted to adjacent said link plates, and a first outstanding portion protruded toward said chain wheel from said combining portion and engaged with one of said tooth spaces of said chain wheel.

2. The chain with tooth type rollers of claim 1, further comprising a bushing closely fitted with said holes on said link plates.

3. The chain with tooth type rollers of claim 1, wherein each of said link plates has at least one protruding parts, each of said protruding parts surrounds said holes and protrudes toward said tooth type rollers, and said protruding parts are closely fitted to said tooth type rollers.

4. The chain with tooth type rollers of claim 1, wherein said first outstanding portion of said tooth type roller has two leaning surfaces respectively facing said adjacent tooth parts of said chain wheel and matched with said tooth parts.

5. The chain with tooth type rollers of claim 4, wherein said leaning surfaces at said first outstanding portion of said tooth type roller are symmetrical designs.

6. The chain with tooth type rollers of claim 4, wherein said leaning surfaces at said first outstanding portion of said tooth type roller are asymmetrical designs.

7. The chain with tooth type rollers of claim 6, wherein one of said leaning surfaces of said tooth type rollers is flat or non-flat when the other of said leaning surfaces is composed of at least two line slices with different curvatures.
